(19) United States
(12) Patent Application Publication
(10) Pub. No.: US 2010/0301609 A1
(43) Pub. Date: Dec. 2, 2010

(54) River-Flow Electricity Generation

(76) Inventors: Chong Hun Kim, Fountain Valley, CA (US); Jennifer Jinhee Kim, Fountain Valley, CA (US); David Kemhoe Kim, Fountain Valley, CA (US)

Correspondence Address: KIM, Chong Hun, 16807 Woodridge Cir., Fountain Valley, CA, 92708, US

(21) Appl. No.: 12/475,478

(22) Filed: May 30, 2009

(51) Int. Cl. F03B 13/10

(52) U.S. Cl. 290/54

(57) ABSTRACT

This invention relates to electricity generation from the river flow by use of mechanical systems, collecting energy day and night regardless of weather condition in a collective manner while isolating a part of the system within a water-proof container. The mechanical system invented generates a force imbalance and thus generates torque to rotate a shaft at a high revolution rate. Two approaches are introduced to create the force imbalance. The first one mechanizes vane operation on a wheel such that pressure builds on one side of the wheel while no pressure builds on the other side. The second one is a “Water-Box” that has an open front side and a door such that pressure builds on the door at one side of the wheel while no pressure builds on the other. Thus, the force imbalance is created and torque is generated to rotate a shaft at a high rate of revolution.

### CROSS-REFERENCE TO RELATED APPLICATIONS

U.S. Patent Documents

| | | | |
|---|---|---|---|
| 7,478,974 | Jan. 20, 2009 | Kelly | 405/78 |
| 7,299,628 | Nov. 27, 2007 | Buller | 60/398 |
| 7,084,521 | Aug. 01, 2006 | Martin | 290/54 |
| 6,861,766 | Mar. 01, 2005 | Rembert | 290/43 |
| 6,396,162 | May 28, 2002 | Carrillo | 290/43 |
| 6,109,863 | Aug. 29, 2000 | Milliken | 415/1 |
| 6,023,105 | Feb. 08, 2000 | Youssef | 290/54 |
| 4,818,888 | Apr. 04, 1989 | Lenoir, III | 290/43 |
| 4,270,056 | May 26, 1981 | Wright | 290/54 |
| 4,224,527 | Sep. 23, 1980 | Thompson | 290/54 |

### BACKGROUND OF THE INVENTION

1. Field of the Invention

This invention relates to electricity generation by converting river-flowing dynamics into rotational dynamics and then into electrical energy by creating force imbalance around a shaft with a mechanical system that consists of vanes, Water-Boxes, wheels, a conveyor belt and drum wheels, part of which are submerged or above the water surface but contained within a water-proof container.

2 Description of the Related Art

Kelly (2009) proposed an invention that uses tapered channels to confine and constrict turbulent tail water into laminar flow that drives turbines both submersible and floatable utilizing the same water three times concurrently to generate new electricity. Buller (2007) invented a scheme in which pressure is built up by use of waterwheel and spiral pump and let the pressure be used to rotate an electrical generator. Martin (2006) used a complex piping system to generate water flow that turns turbine generator to generate electricity. Rembert (2005) uses wind turbine to bring water to an upper reservoir. The water that is stored during off peak is released from the upper reservoir during peak periods. The water will flow down the conduit to the hydro-electric generator producing electricity in the greatly needed peak periods. The hydro-electric generator/pump, which is reversible, is also used to replenish the upper reservoir. This cycle is repeated as often as necessary. Carrillo (2002) proposed installation of penstocks under the river bed and the water carried to underground turbines operate generators for the generation of electricity. Milliken (2000) proposed a fully submersible apparatus equipped with buoyant, counter-rotating side-by-side motors with vanes, and sub-vanes to generate electricity. Youseff (2000) came up with a scheme that creates potential energy of water by lift it to higher ground by use of wind mill and coverts the potential energy to electrical energy. Lenoir, III invented a water wheel that is powered by the blades in contact with the stops, and unhindered by the other blades, and rotates continuously in one direction. Rotation of the wheel causes the drive gear to rotate, which causes the dynamo gears to rotate causing the dynamos to produce electricity. Wright (1981) designed a system in which blades are driven by the moving water and power is generated at the drive shaft, and thus generate electricity. Thompson (1980) proposed a scheme in which natural flow being used to turn about a substantially horizontal axis arranged to act directly on a working fluid, and force it through the pipe systems to generate electricity. Abstracts of these inventions follow.

U.S. Pat. No. 7,478,974 to Kelly (2009) proposed the following. Normally hydroelectric dam powerhouses use river flow once before discharging it as turbulent tail water, ineffective to spin turbines. The present invention uses tapered channels to confine and constrict turbulent tail water into laminar flow that drives turbines both submersible and floatable utilizing the same water three times concurrently to generate new electricity. Channels originate adjacent to draft tube outlets, constrict in the downstream direction to create narrow necks where turbine/generators benefit from debris free, increased velocity and laminar flows to generate electricity. Hydroelectricity uses zero fuel, creates zero waste and has zero carbon dioxide emissions. Structures are uncomplicated, construction is within project boundaries minimizing environmental impacts and speeding projects coming online. New facilities are protected by existing dam security. Hydroelectricity replaces less dependable renewable energy systems.

U.S. Pat. No. 7,299,628 to Buller (2007) proposed the following: An waterwheel using a spiral pump which is attached to a scoop assembly which runs the air and fluid to a separator tank, which then allows the air to an air turbine and the fluid to a hydro turbine will produce pressure which will turn the turbines listed which in turn will rotate an electrical generator producing electricity. This system changes the flow of the river in to rotation movement, which produces pressure, which produces mechanical rotational movement to turn a generator, which generates electricity.

U.S. Pat. No. 7,084,521 to Martin (2006) proposed the following: A hydroelectric power generating method and/or apparatus provides one or more inlet pipes perpendicular to a flow of water in a stream or river. The inlet pipes have a length and plural apertures along the length of the at least one inlet pipe. A feed line and a turbine generator combination are interconnected with the inlet pipes. One or more outlet pipes are interconnected with the feed line and the turbine generator combination. The outlet pipes have an elevation lower than the inlet pipe. A flow of water passes through the inlet pipes, the feed line, the turbine generator combination, and the outlet pipes, and generates electricity from the flow of water passing through the turbine generator combination. The hydroelectric power generating method also provides a pressure dissipation device that causes a reduction in the pressure of the water so that the water can be released safely back into the stream or river.

U.S. Pat. No. 6,861,766 to Rembert (2005) proposed the following: A hydro-electric generating system for generating electrical energy and storing kinetic energy, in which, the process begins with the top reservoir filled with water directly from a river or local utility via a conduit. Then a multi megawatt wind turbine, such as the NEG micron 2-megawatt turbine, placed at heights, on the side of the structure that have never been reached with a man made mast or tower. The mega structure along with the extreme heights of this system will achieve increased wind shear on a high average. The wind turbine is secured to a cart for movement of the cart and the wind turbine. The wind turbine can move to locations along a track relative to wind direction. The wind turbine is the means to power the second pump. The second pump constantly replenishes the upper reservoir with water. The wind turbine produces more electricity than what the second pump requires. This surplus of electricity is sent, via electrical conductors to the regional power grid, which distributes power to cities and towns. The hydroelectric generator/pump, reversible, now has the kinetic energy above that is necessary to turn it's rotor blades and generate megawatts of electricity. This electricity is also sent to the electrical grid system via the electrical conductors. The hydroelectric generator/pump, which is reversible, is also used to replenish the upper reservoir. When back fed with electricity from the regional grid system or the wind turbine. The hydro-electric generator/pump, reverses and functions as a mega pump. This is efficient during off peak periods, when electricity is in less demand and, sold at a lower rate The water that is stored during off peak is released from the upper reservoir during peak periods. The water will flow down the conduit to the hydroelectric generator producing electricity in the greatly needed peak periods, this cycle is repeated as often as necessary.

U.S. Pat. No. 6,396,162 to Carrillo (2002) proposed the following: An underground hydroelectric power plant for use adjacent to rivers, which utilizes an underground water tank connected to multiple underground penstocks. The said penstocks will carry water to underground turbines, which will operate generators for the generation of electricity. This electric energy will be transferred via underground cables to an offsite transformer. The water upon exiting the turbines will be led via an underground outlet pipe back to the river. This underground hydroelectric plant operates on the simple principle that a flowing body of water in a river must have a downward angle to it or the water would not flow and be stagnant, similar to a lake.

U.S. Pat. No. 6,109,863 to Milliken (2000) proposed the following: A fully submersible apparatus for generating electricity from liquid flow as in an ocean or river current. A buoyant structure is fully submersible and has at least one pair of counter-rotating side-by-side motors with a plurality of angularly spaced radial vanes each having a plurality of rotatable subvanes such that current impinging upon the motor will impinge on a closed or solid vane to effect rotation of the motor and its shaft during a first phase of the rotational cycle and will impinge on open vanes for free passage there through on the return or second phase of rotation of the motor. Motors may also be provided with vanes in overlying and underlying relationship. An associated method is provided.

U.S. Pat. No. 6,023,105 to Youssef (2000) proposed the following: Explained herein is a method and equipment whereby windmills are used to directly propel water pumps to lift water from a lower elevation body of water to a nearby higher elevation body of water, where it is stored as potential energy. In one application of this method, one or more water pumps, each powered directly by a windmill, lift water from downstream of a river, stream, or creek to upstream of a dam at which a hydropower plant is installed. The windmill may be of the vertical-axis or horizontal. Upon demand, the lifted water is used to generate electricity utilizing the hydropower plant. An adjustable weir is constructed across the river, stream, or creek downstream the windmill, whose function is to create a reservoir or pool from which water can be pumped and to regulate the flow of water downstream. The adjustable weir can be raised or lowered by means of a jack or jacks that are controlled by a computer. In another application of this invention, one or more water pumps, each powered directly by a windmill is installed at sites having 2 nearby bodies of water, one higher than the other. The bodies of water may be natural or artificial. The water pump lifts water from the low water to the high water, where it is stored as potential energy. Upon demand, the lifted water can be used to generate electricity utilizing a conventional hydropower plant.

U.S. Pat. No. 4,818,888 to Lenoir, III (1989) proposed the following: Water-powered electricity generating apparatus, for use in rivers and other bodies of water having current flow therein, comprises a water wheel and an adjacent platform. The water wheel has a number of blades which are pivotally attached adjacent a first end thereof to vertical rods which extend between the top and bottom of the water wheel. A controllable stop, movable between an upper position in which it may contact a second end of the blade, and a lower position in which contact with the blade is not possible, is provided for each blade. The wheel also comprises a drive gear having downwardly-facing teeth. The drive gear meshes with gears of dynamos carried on the platform adjacent the water wheel. The apparatus is placed in a river or other body of water having current therein. When traveling in an upstream direction, the blades swing freely parallel to the current. When traveling in a downstream direction, the second ends of the blades rest against the stops, and the blade presents a surface against which the current acts to turn the wheel. The wheel, powered by the blades in contact with the stops, and unhindered by the other blades, rotates continuously in one direction. Rotation of the wheel causes the drive gear to rotate, which causes the dynamo gears to rotate causing the dynamos to produce electricity.

U.S. Pat. No. 4,270,056 to Wright (1981) proposed the following: An undershot current motor is provided wherein a horizontal drive shaft is mounted on a float moored or anchored in moving water, the drive shaft being transverse to the moving water below, the drive shaft having at least two sets of 3-bladed paddle assemblies affixed thereon, wherein the blades are driven by the moving water and power is generated at the drive shaft. This new current motor may be used in tidal water or in continuously moving water, such as a river or stream, to generate power for producing electricity for example.

U.S. Pat. No. 4,224,527 to Thompson (1980) proposed the following: A method is described of intensifying a relatively slow speed natural substantially horizontal flow of a natural fluid, such as a tidal flow, as opposed to a tidal rise, or a river flow, the natural flow being used to turn about a substantially horizontal axis rotary means arranged to act directly on a working fluid, which may be the natural fluid, where the latter is a liquid, or a separate liquid, and force it through a pipe system to a flow intensifier in the form of a constriction. The working liquid is forced through the pipe system without the formation of head, and can be used to drive means for generating electricity. Flow intensifying apparatus is also described using seawater as the natural fluid and either fresh water or the seawater as the working fluid. Several of the apparatus may be disposed to cause a vortex or maelstrom which then serves to drive the apparatus.

### BRIEF SUMMARY OF THE INVENTION

These mechanical devices are invented to create a force imbalance around a shaft. The force imbalance is generated by installing vanes (1 in FIG. 1) or Water-Boxes (37 in FIG. 8) on a rotational device such as wheel, and by taking advantage of the fact that the river flows in only one direction. The vanes or Water-Boxes on the top (bottom) of the rotational device are designed to build lateral-pushing pressure toward the direction in which the river flows while on the other side of it they are designed to let the river flow through without building any lateral-pushing pressure in either direction. The force imbalance thus created generates torque around a shaft and causes the shaft to rotate. The rotation energy of the shaft is converted into electrical energy by the electricity generator.

### BRIEF DESCRIPTION OF DRAWINGS

FIG. 1 shows an option of River-Flow Electricity Generation (RIFEG) systems that consist of vanes (1, 13), shafts (3), and a series of pulleys (5, 12, 6, and 7).—Option 1

FIG. 2 shows the structure of the energy collection (53 in FIG. 1) mechanism

FIG. 3 shows the basic structure of the clutch (4 in FIG. 1).

FIG. 4 shows how the clutch works.

FIG. 5 shows a detail clutch (4) mechanism when engaged.

FIG. 6 shows a detail clutch (4) mechanism when disengaged.

FIG. 7 shows another option of River-Flow Electricity Generation (RIFEG) systems that consists of Water-Boxes (36 in FIG. 8), wheel (35, FIG. 7), shafts (3) and a series of pulleys (5, 12, 6, and 7).—Option 2

FIG. 8 explains how the force imbalance is generated on a wheel.

FIG. 9 shows a preferable option of River-Flow Electricity Generation (RIFEG) systems that consists of Water-Boxes (37 in FIG. 10), conveyor belt (45 in FIG. 10), drum wheels (47, 48), shafts (3) and a series of pulleys (5, 12, 6, and 7 ).—Option 3

FIG. 10 explains how the force imbalance is generated on drum wheels (47, 48).

FIG. 11 shows how the Option 1 RIFEG system is to be installed on the river bed.

FIG. 12 shows how the Option 2 RIFEG system is to be installed on the river bed.

FIG. 13 shows how the Option 3 RIFEG system is to be installed on the river bed.

### DETAILED DESCRIPTION OF THE INVENTION

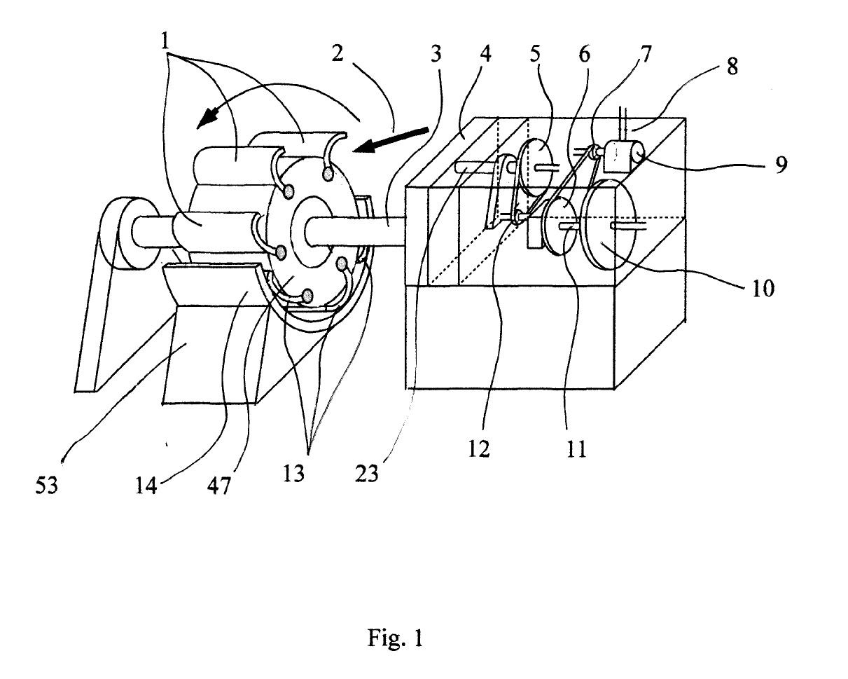

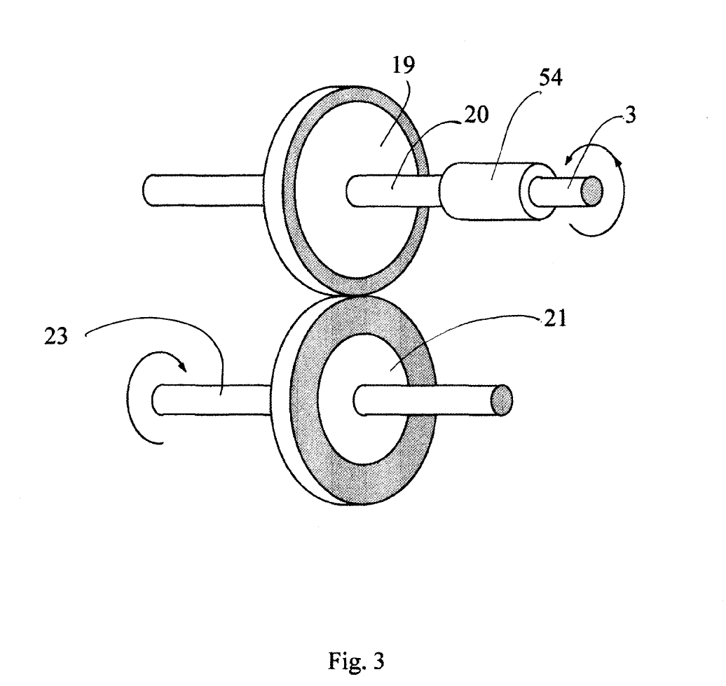

FIG. 1 shows a perspective view of an optional embodiment (Option 1) of RIFEG systems, showing how to convert the river-flow dynamics into rotational energy by installing vanes (1) on the wheel (47) circumference. As the river flows in the direction as shown by the arrow (2), the water pressure builds lateral-pushing pressure on the vanes (1) in the direction of the river-flow at the top of the wheel, while the vanes (13) at the bottom of the wheel (47) are folded into the cover (14) so that no lateral-pushing pressure builds at the bottom of the wheel (47). Thereby, the force imbalance is created and causes the wheel (47) and the shaft (3) to rotate. The shaft (3) is connected to a water sealed shaft (54 in FIG. 3, U.S. Pat. No. 4,398,725) in the clutch box (4) and transmits the rotational motion into the clutch box (4). The water sealed shaft (54 in FIG. 3, U.S. Pat. No. 4,398,725) isolates the rest of the mechanism from the river water. The inside mechanism of the clutch box will be explained later.

The output shaft (23) of the clutch box (4) is connected to pulley (5), and by making the ratio (R1) of pulley (5's) diameter to pulley (12's) diameter larger, the rotational rate of pulley (5) is increased from X RPM (Revolutions Per Minute) to Y RPM. The Y RPM is the rotational rate of the pulley (12). Now, since pulley (12) and pulley (6) share the same shaft (11), pulley (6) rotates at the rate of Y RPM also. The next pair of pulleys (6, 7) increase Y RMP to Z RPM by making the ratio (R2) of pulley (6's) diameter to pulley (7's) diameter larger. The Z RPM is the rotational rate of the pulley (7). Here, the Z RPM is equal to the product of R1 and R2 and X RPM (i.e. Z RPM=R1*R2*X RPM). R1 and R2 are determined to meet the generator RPM requirement to generate electricity. The electricity generator (9) shaft is connected to gear (7) shaft and the electrical wires (8) are water shielded.

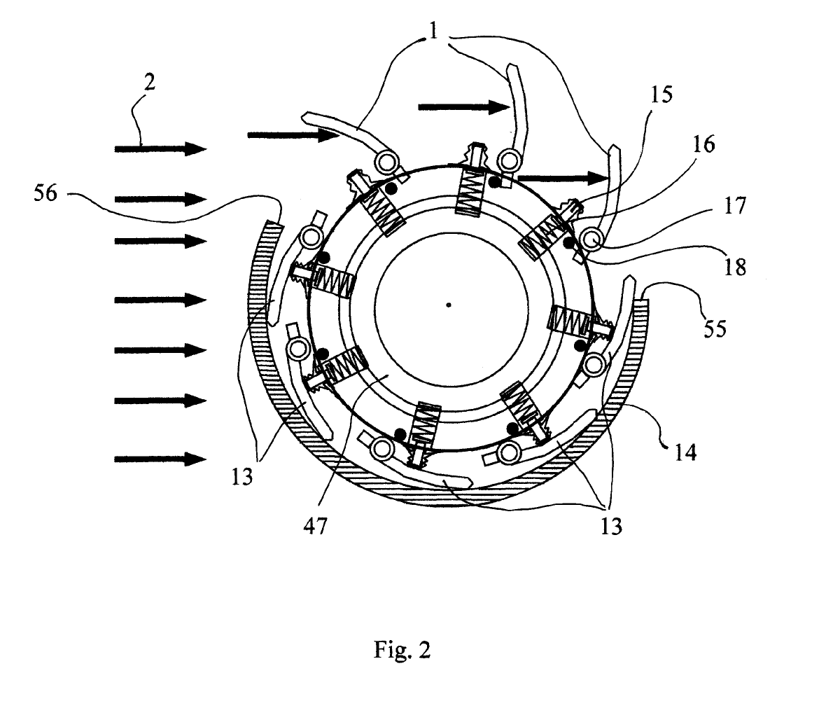

FIG. 2 shows a configuration of an energy collection mechanism. In this figure, the river flows from left to right, and the water-flow in this direction pushes the vanes (1) of the wheel (47) to the right and rotates the wheel (47) clockwise. As a vane (1) passes through the entrance (55) of the cover (14) (see the right side of FIG. 2), the fixture at the entrance (55) of the cover (14) pushes the vane down toward the center of the wheel (47) so that it can move inside the cover (14). At the same time, it also presses a small mass (15) and the spring (16) down in the same direction. The vanes inside the cover stay folded until they reach the exit (56) of the cover (14). As the vane passes through the exit (56) of the cover (14), the depressed spring (16) releases its depressed energy and pushes the vane toward the centrifugal direction and deploys the vane (1). In this figure, three vanes (1) are deployed and five vanes (13) are folded inside the cover (14). This configuration creates force imbalance because lateral-pushing pressure builds up at the top of the wheel (47) where the vanes (1) are deployed, while no lateral-pushing pressure builds up at the bottom where the vanes (13) are folded inside the cover. The force imbalance thus created causes the wheel (47) to rotate. Vane stopper (18) holds the vane against the water pressure.

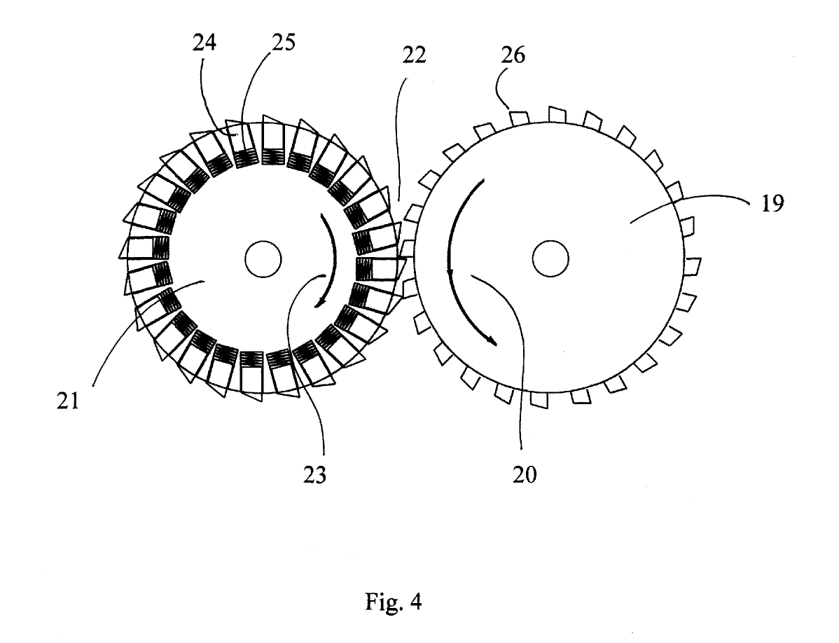

FIG. 3 shows the basic structure inside the clutch box (4). The shaft (20) is the input shaft that is connected to the shaft (3 in FIG. 1) via a water-sealed shaft (54, U.S. Pat. No. 4,398,725). The input shaft (20) angular rate may not be consistent as shown with two arrows in the figure. (The inconsistency is due to the fact that the river may not flow at a consistent speed.) But, the output shaft (23) angular rate is relatively consistent once it reaches a certain angular rate. The designs of the mechanisms (19, 21) are shown in FIG. 4.

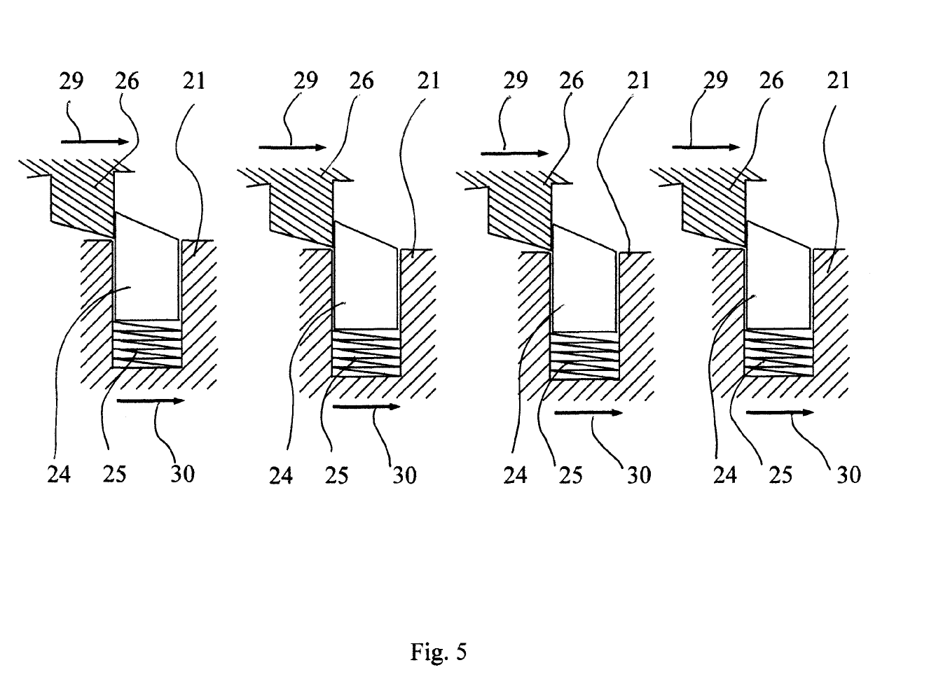

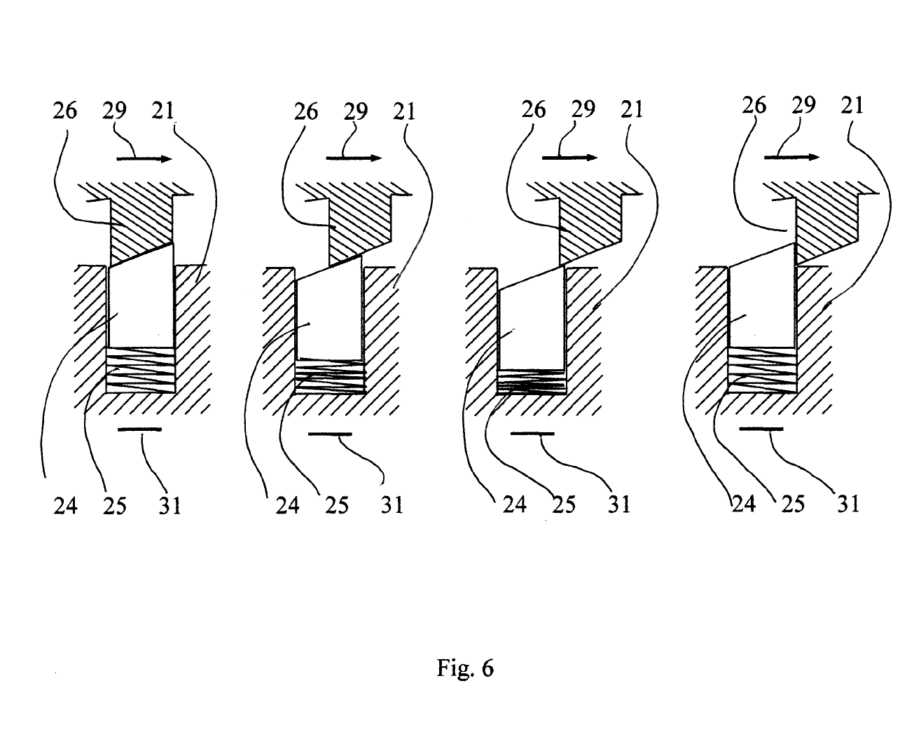

FIG. 4 shows how gear (19) and gear (21) engage and disengage (22). As the gear (19) turns counter clock wise, the teeth of gear (19) pushes the teeth of gear (21) and consequently gear (21) turns clock wise (see contact between gear (19) and gear (21): (22)). Gear (19) never turns clockwise because the river flows in one direction only, but its counter-clockwise turning rate may fluctuate depending upon the speed of the river flow. The engagement and disengagement mechanism is designed in such a way that once the output rotational rate (23) reaches a certain rate, it maintains its rate even when the input rotational rate (20) decreases below the output rotational rate (23). The mechanism is explained in FIG. 5 and FIG. 6.

FIG. 5 shows the case when the two gears (19, 21) are engaged. As the gear (19 in FIG. 4) rotates counter clock wise (29), tooth (26) moves to the right and pushes tooth (24) of gear (21) to the right (30) and causes gear (21 in FIG. 4) to rotate clockwise.

FIG. 6 shows the case when the two gears (19, 21) are disengaged. When gear (19) rotates slower than gear (21), tooth (26) of gear (19 in FIG. 4) pushes tooth (24) of gear (21 in FIG. 4) downward (toward the center of the gear). The downward pushing is possible because there is a spring (25) underneath tooth (24). After pushing tooth (24) all the way down, tooth (26) passes tooth (24) without pushing it to the right (31), and thus the disengagement occurs.

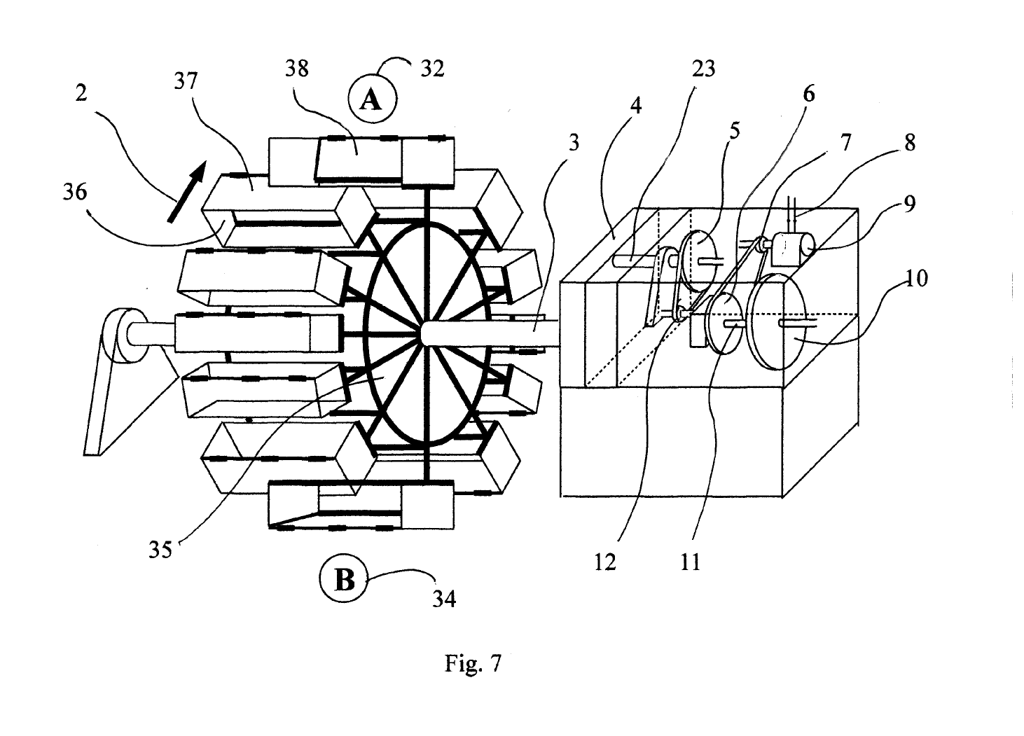

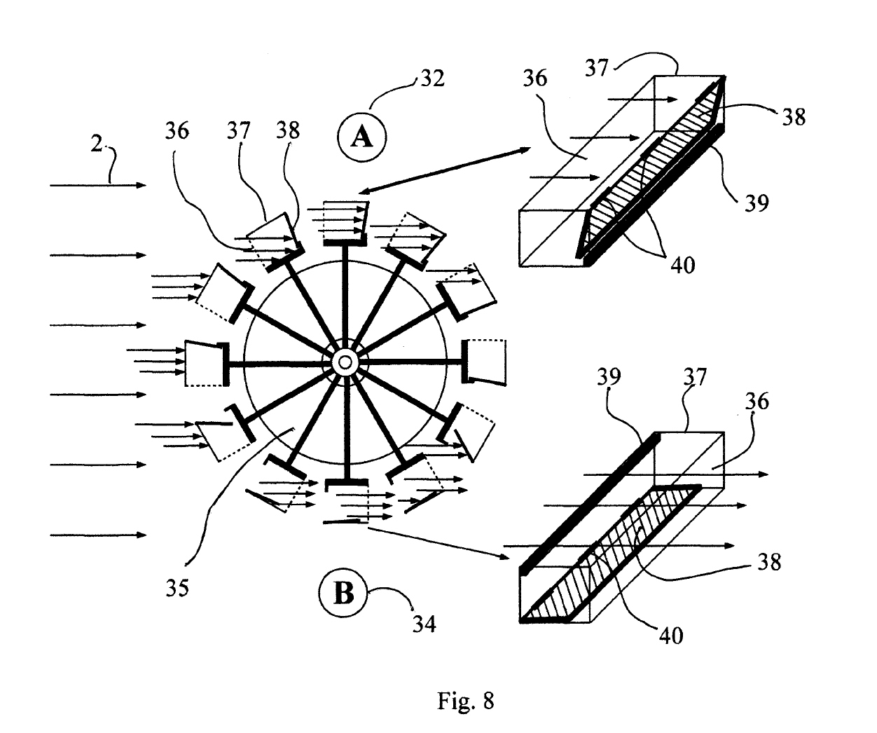

FIG. 7 shows a perspective view of an optional embodiment (Option 2) of RIFEG systems, showing how to convert the river-flow dynamics into rotational energy by installing Water-Boxes (37) on the wheel (35) circumference. As the river flows in the direction as shown by arrow (2), the Water-Box (37) at the top “A” of wheel (35) collects the water that flows in through the front opening (36). The water collected stays in the box because the door (38, see FIG. 8 for detail) is closed by the river water pressure and stops the water from flowing through. There is a stopper (39) that prevents the door (38) from swinging beyond the position where the stopper (39) is installed. And the water mass within the Water-Box (37) pushes the Water-Box (37) to the right (lateral-pushing) and turns wheel (35) clockwise. While the lateral-pushing by the river-flow is taking place at the top area “A” (32), the Water-Boxes at the bottom area “B” (34) passes the water through the back and front (36) openings. The door-opening occurs here because there is no stopper when the door (38) rotates clockwise (see bottom of FIG. 8 for detail). Now, the force imbalance between the top “A” (32) and the bottom “B” (34) causes the wheel (35) and the shaft (3) to rotate clockwise (see FIG. 8 for detail). The shaft (3) is connected to a water-sealed shaft (54 in FIG. 3, U.S. Pat. No. 4,398,725) and transmits the rotational motion into the clutch box (4). The water-sealed shaft (54 in FIG. 3, U.S. Pat. No. 4,398,725) isolates the rest of the mechanism from the river water.

The output shaft (23) of the clutch box (4) is connected to pulley (5), and by making the ratio (R1) of pulley (5's) diameter to pulley (12's) diameter larger, the rotational rate of pulley (5) is increased from X RPM (Revolutions Per Minute) to Y RPM. The Y RPM is the rotation rate of pulley (12). Now, since pulley (12) and pulley (6) share the same shaft (11), the pulley (6) also rotates at the rate of Y RPM. The next pair of pulleys (6, 7) increase Y RMP to Z RPM by making the ratio (R2) of pulley (6's) diameter to pulley (7's) diameter larger. The Z RPM is the rotational rate of the pulley (7). Here, the Z RPM is equal to the product of R1 and R2 and X RPM (i.e. Z RPM=R1*R2*X RPM). R1 and R2 are determined to meet the generator RPM requirement to generate electricity.

FIG. 8 explains how the wheel (35) rotates. The Water-Box (37) (see top right) has an opening (36) in the front and a door (38) in the rear, hinged (40) at the top. It swings forward and opens the passage. But when it swings back from the opened position, the stopper (39) stops the door (38) and it blocks the water-flow.

The Water-Boxes (37) at the top “A” (32) of the wheel (35) have the doors (38) closed as the doors (38) are pushed toward the back by the river-flow pressure. As the water mass in the Water-Box (37) moves to the right, it pushes the Water-Box (37) to the right and it causes the wheel (35) to rotate clockwise. On the other hand, the door (38) of the Water-Boxes (37) at the bottom “B” (34) are forced open by the river-flow pressure and they let the river flow through the Water-Boxes (37), thus no counter balancing force is generated at the bottom “B” (34). Thereby, force imbalance is created and it causes the wheel (35) to rotate.

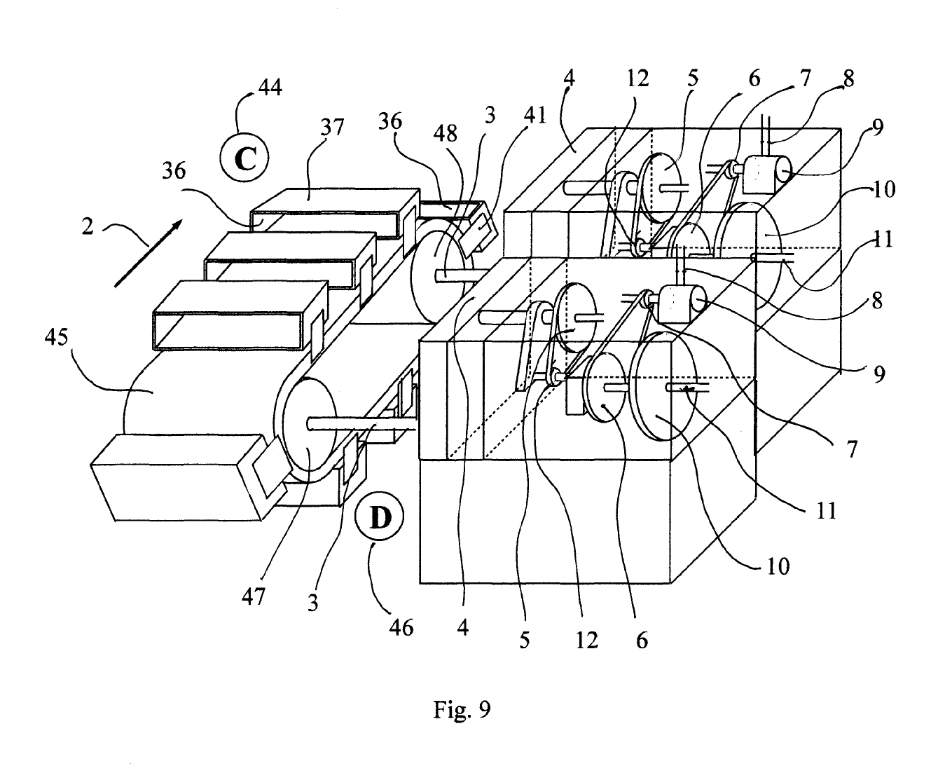

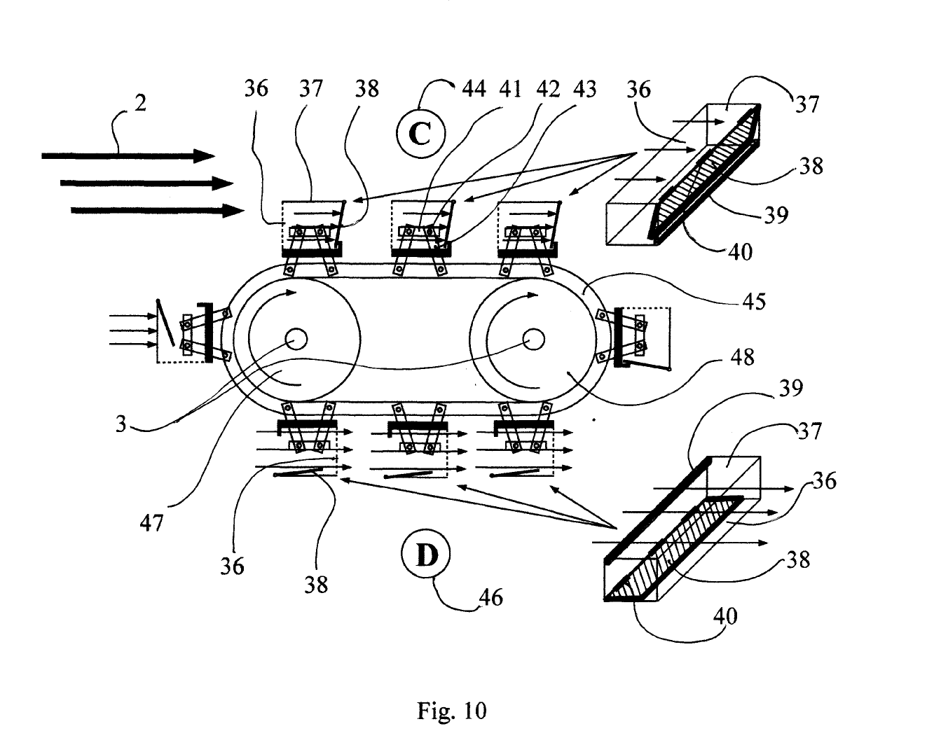

FIG. 9 shows a perspective view of a preferred embodiment (option 3) of RIFEG systems, showing how to convert the river-flow dynamics into rotational energy by installing Water-Boxes (37) on a conveyor belt (45) that runs around two drum wheels (47, 48). As the river flows in the direction as shown by arrow (2), the Water-Boxes (37) on the top “C” (44) collect the water that flows in through the opening (36). The water collected stays in the boxes because the doors (38 in FIG. 10) are closed by the river water pressure and stops the water from flowing through. There is a stopper (39) in each Water-Box (37) that prevents the door (38) from swinging beyond the position where the stopper (39) is installed. And the water mass within the Water-Boxes (37) pushes the Water-Boxes (37) toward the river-flow direction (lateral-pushing) and it causes the conveyor belt (45) to move in the same direction and turns the drum wheel (47, 48) clockwise. While the lateral-pushing by the river flow is taking place at the top area “C” (44), the Water-Boxes at the bottom area “D” (46) pass the water through the back and front (36) openings. The door opening occurs here because there is no stopper as the door (38) rotates clockwise (see FIG. 10 for detail). Thus, the force imbalance is created between the top “C” (44) and the bottom “D” (46), and it causes the conveyor belt (45) and the shafts (3) to rotate clockwise (see FIG. 10 for detail). The shafts (3) are connected to water-sealed shafts (54 in Fig., U.S. Pat. No. 4,398,725) and transmit the rotation motion into the clutch boxes (4). The water-sealed shafts (54 in FIG. 3, U.S. Pat. No. 4,398,725) isolate the rest of the mechanisms from the river water.

The output shaft (23) of the clutch box (4) is connected to pulley (5), and by making the ratio (R1) of pulley (5's) diameter to pulley (12's) diameter larger, the rotation rate of pulley (5) is increased from X RPM (Revolutions Per Minute) to Y RPM. The Y RPM is the rotational rate of the pulley (12). Now, since pulley (12) and pulley (6) share the same shaft (11), pulley (6) also rotates at the rate of Y RPM. The next pair of pulleys (6, 7) increase Y RMP to Z RPM by making the ratio (R2) of pulley (6's) diameter to pulley (7's) diameter larger. The Z RPM is the rotational rate of the pulley (7). Here, the Z RPM is equal to the product of R1 and R2 and X RPM (i.e. Z RPM=R1*R2*X RPM). R1 and R2 are determined to meet the generator RPM requirement to generate electricity.

FIG. 10 explains how the drum wheels (47, 48) rotate. The Water-Box (37) (see top right) has an opening (36) in the front and a door (38) in the rear, hinged (40) at the top. It swings forward and opens the passage. But when it swings back from the opened position, the stopper (39) stops the door (38) and blocks the water flow.

The Water-Boxes (37) at the top “C” (44) of the conveyor belt (45) have the doors (38) closed as the doors (38) are pushed back by the river-flow pressure. Since the door (38) blocks the water flow, the water in the Water-Box (37) stays inside. As the water mass in the Water-Box (37) moves to the right, it pushes the Water-Box (37) and the conveyor belt (45) to the right and causes the drum wheels (47, 48) to rotate clockwise. On the other hand, the doors (38) of the Water-Boxes (37) at the bottom “D” (46) of the conveyor belt (45) are forced open by the river-flow pressure and let the river water flow through the Water-Boxes (37), and thus no counter balancing force is generated at the bottom “D” (46). Thus, the force imbalance between the top “C” and the bottom “D” is created and causes the conveyor belt (45) to rotate. Hinge (42), arm1 (41), and arm2 (43) are parts of Water-Box (37), the function of which is to connect the Water-Box (37) to the conveyor belt (45) so that as the Water-Box (37) moves to the right, it pulls the conveyor belt (45) along with it, and enable the Water-Box (37) to move along the round surface of the circumference of the drums (47, 48).

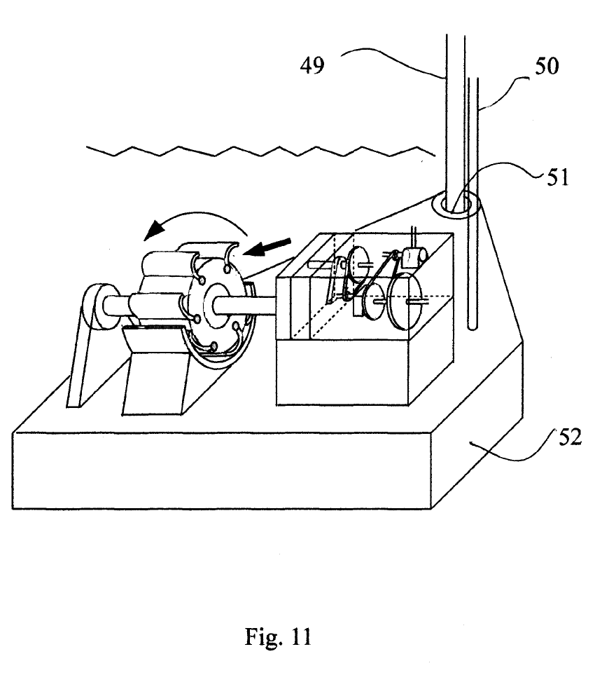

FIG. 11 shows how the Option 1 RIFEG system is installed. First, a pole (49) is lowered to the bottom of the river bed and fixed at a location where the system is to be installed. The hole (51) of the Option 1 RIFEG system is to bring the system down to the river bed along the pole (49). The lowering is done by filling the water through the water pipe (50) into the ballast (52). The size of ballast (52) is such that when it is filled with the water, the whole system stays put at the location where it is installed. The ballast (52) system is used to make it easier to bring down the system to the river bed and to raise the system above the water when maintenance is needed.

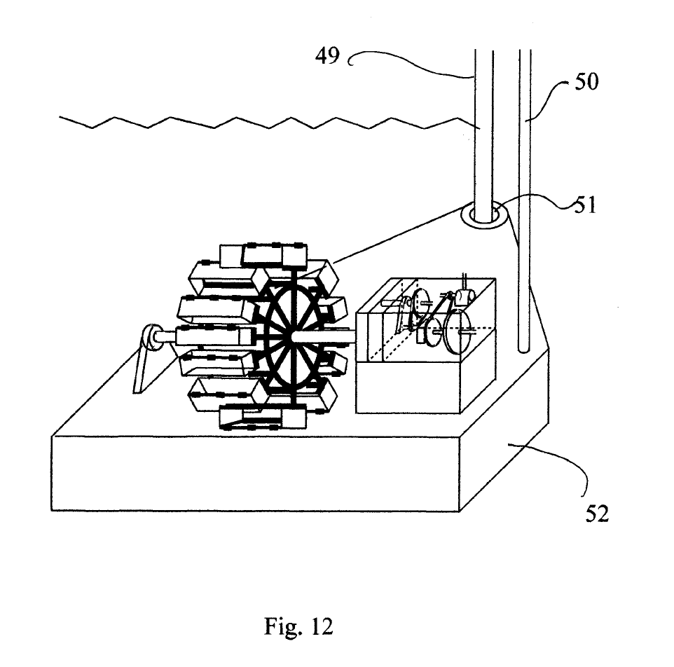

FIG. 12 shows the same as FIG. 11 except that the RIFEG system is Option 2 as shown in FIG. 7.

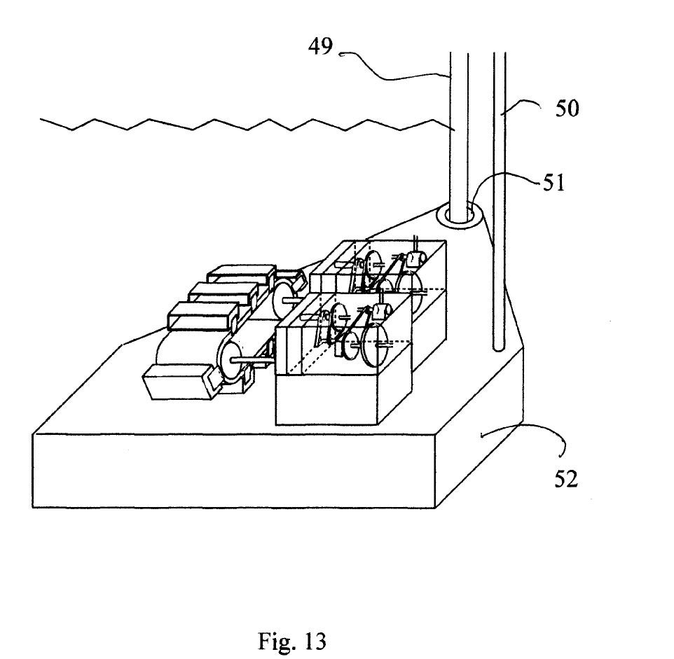

FIG. 13 shows the same as FIG. 11 except that the RIFEG system is Option 3 as shown in FIG. 9.

The embodiments of the invention in which an exclusive property or privilege is claimed are defined as follows:

1. A system of electricity generation wherein the river-flowing dynamics is converted into rotational dynamics and then into electricity by creating force imbalance around an axis with a mechanical system that consists of necessary mechanical elements is comprising:
(a) vanes, cover, cover entrance fixture, and associate spring mass systems installed on the circumference of a circular wheel, being the necessary mechanical elements recited above, wherein as the river flows, the vanes at one side of said wheel face the water flow and lateral-pushing pressure builds up against the vanes while vanes at the other side of said wheel get folded down by said cover entrance fixture as the vanes enter into the cover area and the vanes are stored inside the cover in a folded configuration such that no lateral-pushing pressure builds up against these vanes, and thus said force imbalance is created and that causes said wheel to rotate,
(b) spring mass system recited above, wherein as said vane is being folded in by a fixture at the entrance of said cover, it presses said mass and said spring toward the center of said wheel and the spring energy is stored and remains stored until said vane passes an exit hole, and as said vane is passing the exit hole at the end of the cover area, said spring releases its energy and pushes said vane upward so that said vane is forced to be opened and in a position that it faces against the river-water flow, thus lateral-pushing pressure builds up upon said vane and it pushes the vane in the direction of the river-water flow,
(c) a clutch mechanism wherein a gear (A) gets engaged with another gear (B) when said gear (A) rotates faster than the other gear (B) and disengages when said gear (A) rotates slower than said other gear (B),
(d) Said clutch mechanism wherein the gear tooth face angles of the gear (A) and the gear (B) are the same, and said gear (B) is not fixed but movable up and down and has a spring underneath such that as the gear (A) tooth moves in one direction such that as said two tooth faces are sliding with each other, said gear (A) tooth pushes said gear (B) tooth downward to the direction of the center of said gear (B) but not in the direction that said gear (A) moves, and thus disengagement occurs, while if said gear (A) moves in the other direction in the relative sense, then instead of sliding, said two gears (A and B) are facing each other and said gear (A) pushes said gear (B) in the direction in which said gear (A) moves, thus the gear engagement occurs,
(e) “Water-Boxes” installed on the circumference of a circular wheel, being as the necessary mechanical elements wherein said Water-Box has an opening in the front and has a door in the rear that is hinged at the top (or bottom) and has a stopper on the other side of the hinge such that said door can be opened in one direction (so that the water can flow through) but not in the other direction so that as the river flows, Water-Boxes at the top (bottom) of said wheel get filled with water and the water pushes the Water-Boxes and said wheel in the direction of the river flow, while said Water-Boxes at the bottom (top) pass the water through front and rear openings and no lateral-pushing pressure can be generated, and thus said force imbalance between top and bottom is created and it causes said wheel to rotate,
(f) “Water-Boxes” installed on a conveyor belt, being as the necessary mechanical elements wherein said Water-Box has an opening in the front and has a door in the rear that is hinged at the top (or bottom) and has a stopper on the other side of the hinge such that said door can be opened in one direction (so that the water can flow through) but not in the other direction so that as the river flows, Water-Boxes at the top (bottom) of said conveyor belt get filled with water and the water pushes the Water-Boxes and said conveyor belt in the direction of the river flow, while said Water-Boxes at the bottom (top) pass the water through front and rear openings and no lateral-pushing pressure can be generated, and thus said force imbalance between top and bottom is created and it causes said conveyor belt to rotate.
